(19) United States
(12) Patent Application Publication
(10) Pub. No.: US 2011/0315284 A1
(43) Pub. Date: Dec. 29, 2011

(54) ARM AND LEG PURSE APPARATUS

(76) Inventors: Michelle Hause, Bayport, MN (US); Jeffrey Hause, Bayport, MN (US)

(21) Appl. No.: 13/149,592

(22) Filed: May 31, 2011

Related U.S. Application Data
(60) Provisional application No. 61/349,554, filed on May 28, 2010.
(60) Provisional application No. 61/364,720, filed on Jul. 15, 2010.

(51) Int. Cl. A45C 13/24; A45C 13/30; A45C 13/18; G08B 3/00; A45C 1/02

(52) U.S. Cl. 150/101; 340/384.1; 150/111; 150/110; 150/108

(57) ABSTRACT

A purse system includes a first purse having a first connection point therein and a second purse, having a second connection point therein for removably attaching the second purse to a position within the first purse. The strap of the second purse includes a third connection point which interacts with the second connection point. The purse system can also include an alarm system.

### RELATED APPLICATIONS

The present application claims the benefit of U.S. provisional patent application No. 61/349,554 filed May 28, 2010, and U.S. provisional patent application No. 61/364,720 filed Jul. 15, 2010, which are both incorporated by reference herein for any purpose.

### FIELD OF THE INVENTION

The present inventions relates to an arm and leg purse apparatus for wearing externally on the arm or leg of a person.

### BACKGROUND

Purses are generally come in all sizes. The size is usually too big for some to carry when partaking in certain activities. For example, if a woman is in a night club and is asked to dance, many times a purse will be left at a table under the watchful eye of a friend. Sometimes it is merely left at the table unattended. Unfortunately, some may be tempted by a potentially valuable item being left unattended and may snatch the purse. This of course causes trouble since the purse is usually thrown away after the thief has rifled through the purse or handbag looking for valuables. The owner not only loses their valuables, but loses credit cards, a driver's license, passports or whatever other documents may be stored therein. Of course, these items take a lot of effort and time to replace and there is a possibility that someone may use the credit cards to buy all sorts of items. Still a further threat is that someone may steal the person's identity. Still another possibility is that a bad actor might go through the purse and record valuable data (social security numbers, credit card numbers, and the like) and replace the purse more or less as they found it. The unsuspecting victim will not go to the effort of calling various credit card companies and banks to minimize the amount of fraudulent spending conducted using information found within the purse. The unsuspecting victim will think everything is alright while the bad actor goes out and spends like crazy. This would allow the bad actor to rack up more bills in the name of the victim and produce a large mess for the victim to straighten out. Analytic programs run by various banks may “kick in” to alert the victim to overspending or spending outside the victim's normal patterns.

### BRIEF DESCRIPTION OF THE DRAWINGS

FIG. 1 is a perspective view of a purse system, according to an example embodiment.

FIG. 2 is perspective view of the second purse, according to an example embodiment.

FIG. 3 is close up view of the hardware used to attach the purse to an arm or leg of the wearer, according to an example embodiment.

FIG. 4 is a view showing the interior of the first purse of the purse system, according to an example embodiment.

FIG. 5 is a perspective view of an arm and leg purse being worn on the leg, according to an example embodiment.

FIG. 6 is a schematic view of an alarm system associated with the purse system, according to an example embodiment.

FIG. 7 is a schematic view of a purse having a global positioning sensor that can be used to locate the purse, according to an example embodiment.

FIG. 8 is a front view of a purse with a holster style strap for attaching to the leg of a wearer, according to an example embodiment.

FIG. 9 is a front view of a purse having a set of straps for attaching to the leg and waist of a wearer, according to an example embodiment.

FIG. 10 is a front view of a purse having a double set of straps for attaching to a wearer, according to an example embodiment.

FIG. 11A is a front view of a purse having a removably attachable strap for attaching to the waist of a wearer, according to an example embodiment.

FIG. 11B is a front view of a purse having a belt slot for attaching to a belt or other strap of a wearer, according to an example embodiment.

FIG. 11C is a front view of a purse having a hooks for attaching to a belt or other strap of a wearer, according to an example embodiment.

FIG. 12A is a front view of a purse having a removably attachable body strap for attaching to a wearer, according to an example embodiment.

FIG. 12B is a front view of the purse shown in FIG. 12A without the removably attachable body strap or configured as a clutch purse, according to an example embodiment.

FIG. 12C is a front view of the purse shown in FIG. 12A having a removably attachable body strap attached to the purse so the purse is configured as a hand held or shoulder carrier purse, according to an example embodiment.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements for various applications will likewise be within the skill of the art after the following description has been read and understood.

Where used in various Figures of the drawings, the same numerals designate the same or similar parts. Furthermore, when the terms “top,” “bottom,” “right,” “left,” “front,” “rear,” “first,” “second,” “inside,” “outside,” and similar terms are used, the terms should be understood to reference only the structure shown in the drawings and utilized only to facilitate describing the illustrated embodiments.

### DETAILED DESCRIPTION OF THE INVENTION

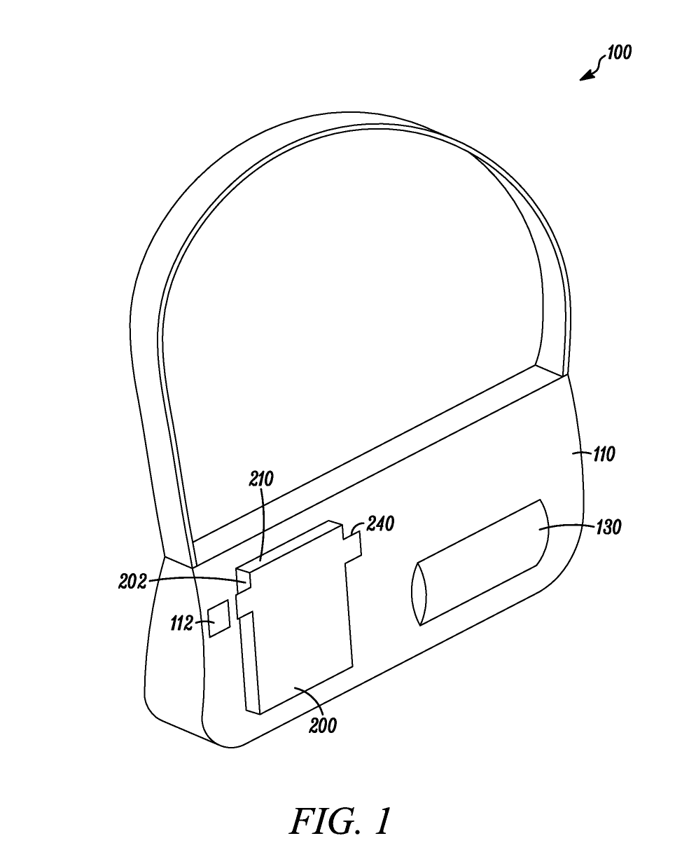

FIG. 1 is a perspective view of a purse system 100, according to an example embodiment. The purse system 100 includes a first purse 110 and a second purse 200 attached within the first purse 110. The first purse includes various compartments for carrying various items, such as a wallet 130, a cosmetic case, and the like. The first purse 110 also includes an attachment point or connection point 112 for the second purse 200. The second purse 200 is positioned so that the contents of the second purse 200 will stay within the second purse 200. The connection point 112 also connects the purse so that it is in a position to allow easy access to the second purse 200 when it is attached to or attached within the first purse 110. In other words, the second purse includes an access opening 202. The access opening 202 will be accessible when the second purse is attached.

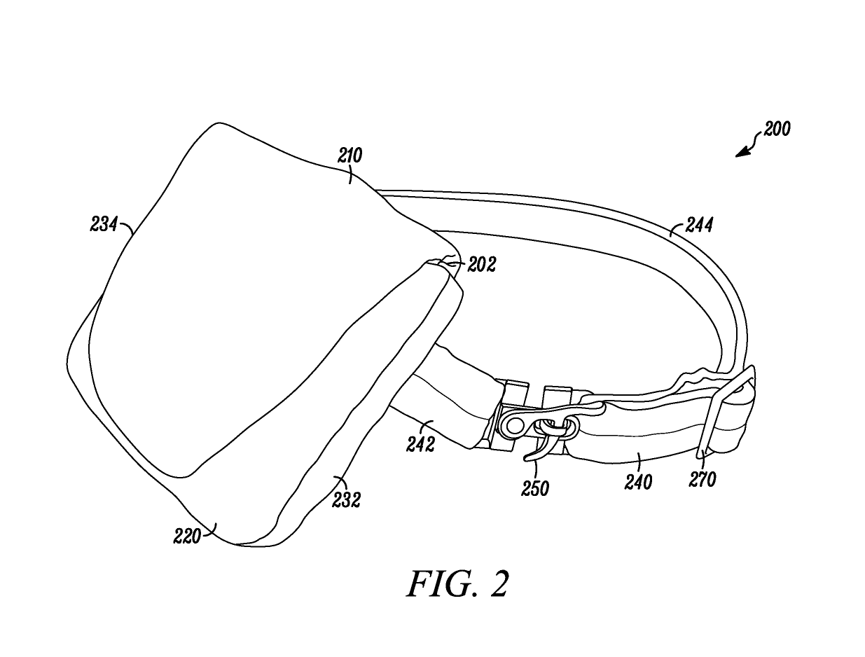

FIG. 2 is perspective view of the second purse 200, according to an example embodiment. The second purse 200, as mentioned previously, includes an access opening. As shown in FIG. 2, the second purse 200 includes a flap 210. The flap 210 covers an access opening 202 to the interior portion of the second purse 200. When attached within the first purse 110, the flap 210 of the second purse is presented to the user when the first purse is opened. The flap 210 can then be moved to open the second purse 200 to get the contents of the second purse. In this way, the user can order the contents of the purse system 100 by a desired system and place related items in the second purse 200. The second purse 200 can be removed from the first purse 110 when desirable. The second purse 200 can include the more valuable items associated with the purse system 100. The second purse 200 can include the more important items associated with the purse system 100, such as personal items of special value to the user. In addition, the user may include frequently used items in the second purse 200, such as security items for gaining access to a work place or a vehicle. For example, the second purse 200 may be used to hold a security badge used to gain access to work or to a parking garage, or to hold a spare key for a vehicle. In this way, the second purse 200 acts as a default location where an item is always placed and always can be found. This minimizes the time consuming process of digging in ones purse for important items that need to be found. This is especially handy if certain items need to be found quickly. Of course, the organization of the purse is accomplished by the user and is based on criteria set by the user. The second purse 200 and the items therein can be removed from the purse whenever desired. For example, sometimes it may not be convenient to take an entire purse along for certain activities. For certain activities, a purse is left in the car. It may be a social event where it is impractical to take the larger purse 110 along. It may be a dance where taking the larger purse is awkward. With the purse system 100, the user may leave the first purse 110 and take only the second purse 200. The second purse 200 is detached from the anchor point within the first purse 110.

The second purse 200 includes a flap 210, a bottom 220, a first side 232, and a second side 234. The second purse 200 also includes a strap 240. The strap 240 includes a first end 242 which is attached to the first side of the second purse 210 and a second end with is attached to the second side 234 of the second purse 200. The ends 242, 244 of the strap 240 attached to a first edge 232 and the second end 234 of the second purse 200 at a point between the flap 210 and the bottom 220 of the purse. Intermediate along the length of the strap 240 is a portion that includes hardware 250.

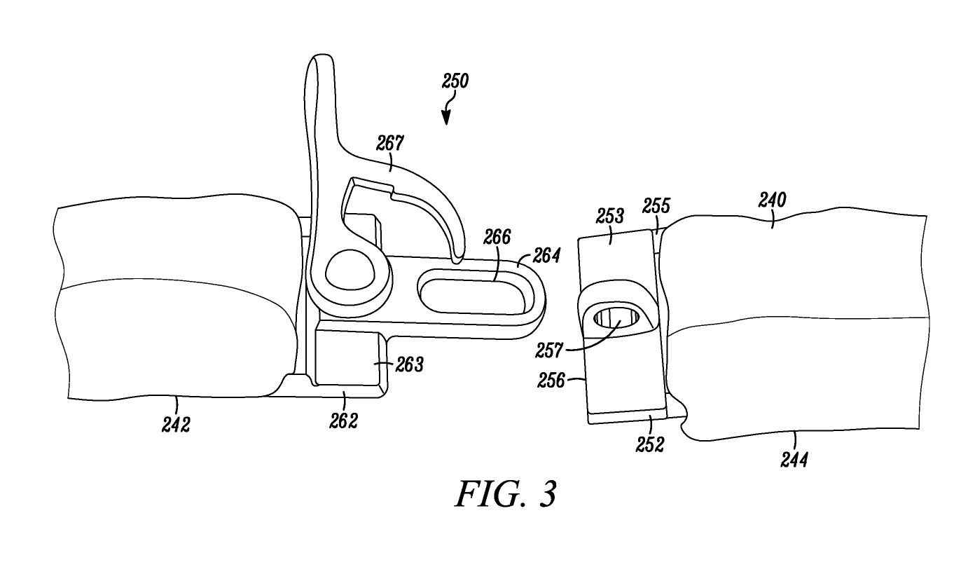

FIG. 3 is close up view of the hardware 250 used to attach the purse to an arm or leg of the wearer, according to an example embodiment. Now referring to both FIGS. 2 and 3, the hardware 250 will be further detailed. The hardware 250 includes a first portion 252 and a second portion 262. When the first portion 252 is connected to the second portion 262, a continuous loop of material is formed that can be used to attach the second purse 200 to a limb of the user. When the first portion 252 is disconnected from the second portion 262, the loop is broken so that the second purse 200 can be easily removed from the limb. At least one of the first end 242 or the second end 244 of the strap 240 includes a length adjusting apparatus 270 (shown in FIG. 2). This allows the total length of the loop formed by attaching the first end 242 and the second end 244 of the strap to be adjusted to various limb sizes. The first hardware portion 252 includes a flat surface 253 approximately the width of the strap 240. The flat surface 253 has an elongated opening therein 255 on one end for receiving an end of the strap 240. The flat surface 253 also includes an upright 256 having an opening 257 therein. The upright extends out from the flat surface. The second hardware portion 262 includes a second flat surface 263. An elongated arm member 264 is attached to the second flat surface. The elongated arm member includes an elongated slot opening 266. The elongated slot opening 266 has a width that receives the upright 256. The elongated arm member 264 has a thickness which is less than the distance between the opening 257 in the upright 256 and the flat surface 253. When connecting the first hardware portion 252 and the second hardware portion 262, the opening 257 in the upright 256 is above the surface of the elongated arm member 264 and the flat portions 253, 263 substantially abut one another. The second hardware portion 262 includes a hook 267 which is pivotally attached to the flat portion 263 and the elongated arm member 264. The end of the hook 267 engages the opening 257 as the hook is rotated. The hook 267 actually includes a cross section which is small on the end and gets progressively larger in cross section. As a result, the hook 267 engages the opening 257 as a mechanical wedge.

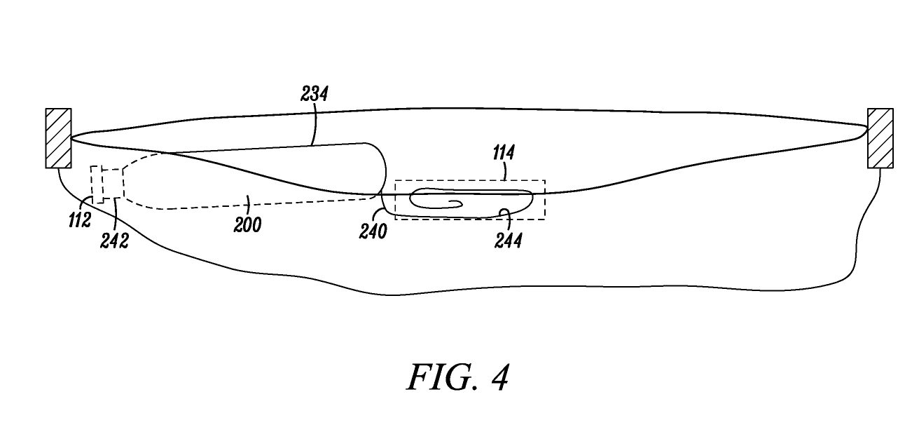

FIG. 4 is a view showing the interior of the first purse 110 of the purse system 100, according to an example embodiment. One of the first portion 252 or the second portion 262 of the hardware is replicated and attached to the interior of the purse 110 of the purse system 100. As shown in this embodiment, the first portion 252 is replicated within the purse. In this way, the second purse 200 can be attached to the interior of the first purse 110 by attaching the second hardware portion 262 with the first hardware portion 252 attached to the interior of the purse 110. The interior of the purse 110, in some embodiments, includes a pocket 114 for receiving the loose or unnattached portion of the strap 240. The pocket 114 keeps the interior of the purse neater since a long portion or unattached portion of the strap 240 is not loose within the first purse 110. One of the first portion 252 or the second portion 262 of the hardware 250 attaches directly to the attachment portion of the interior of the purse 110. It should be noted that other types of hardware can be employed to attach the strap portions and form a continuous strap 240.

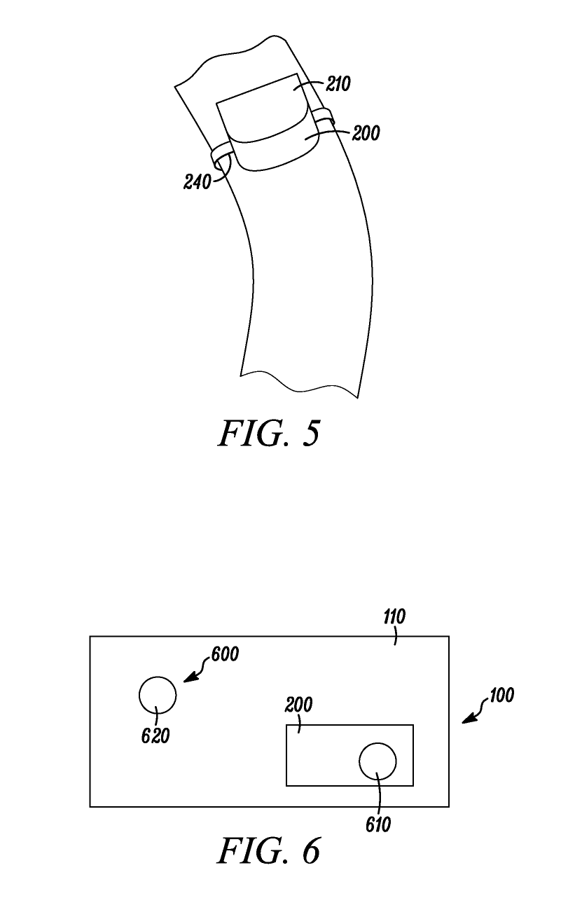

FIG. 5 is a perspective view of an arm and leg purse being worn on the leg of a person, according to an example embodiment. As shown, the second purse 200 can be worn directly an extremity, such as an arm or leg, of the user. In some embodiments the purse 200 can made to fit on an animal, such as a pet dog or cat or even a horse or the like. Generally, the purse 200, when used for an animal is adapted to fit on the neck of the animal. As shown, In FIG. 5, the purse 200 is fitted to the arm of the user. The purse 200 can be worn on the outside of clothing so that the purse 200 and the contents of the purse 200 can be carefully watched during an activity. The purse 200 may be made to be fashionable considering that it can be worn on the outside the clothing.

FIG. 6 is a schematic view of an alarm system 600 associated with the purse system 100, according to an example embodiment. The alarm system 600 includes at least one alarm 610 associated with one of the first purse 110 or the second purse 200. The alarm 610 can be any type of alarm, such as an audible alarm or a silent alarm. In one embodiment, the alarm 610 is associated with the second purse 200. In one embodiment, the alarm 610 emits a radio signal when it is out of range of another alarm portion, such as a second alarm portion 620 associated with the first purse 110. In this embodiment, this might prevent the user of the purse system 100 from leaving or forgetting one portion of the purse system because the separation would sound and alarm or emit a radio frequency that would cause interference on a car radio, for example. In another embodiment, the alarm could be an RF transmitter that produced a signal in response to an RF reader being present. The RF transmitter may be programmed to transmit information regarding the user of the purse. For example, it may transmit the owners name or a code word that the user must give to a person to pass. Such an alarm could deter theft and be used as a marketing point for some firms. It should be noted that the alarm system can be a number of individual alarms associated with various portions of the purse system 100. For example, a first alarm, such as alarm 610 can be associated with the first purse 110 and a second alarm 620 can be associated with the second purse 200. The alarm may be audible or silent and may produce a signal which can be read at a corresponding reading station.

A purse system includes a first purse 110 having a first connection point 112 therein and a second purse 200, having a second connection point therein for removably attaching the second purse 200 to a position within the first purse 110. The second purse 200 being smaller than the first purse 110. The second purse 200 includes a strap 240 of sufficient length to attach to a person's appendage. The strap 240 generally has sufficient length to wrap around a person's arm or a person's leg. The strap 240 of the second purse includes a third connection point which interacts with the second connection point. When the third connection point is connected to the second connection point the strap is a loop of sufficient length to encompass a user's appendage or limb. The second connection point and the third connection point on the strap 240 can correspond to hardware 250 associated with the second purse 200. The loop is also adjustable to accommodate different sized appendages. In one embodiment, the third connection point on the strap of the second purse is substantially identical to the first connection point 112 of the first purse. In one embodiment, the second connection point and the third connection point of the strap 240 correspond to the hardware 250 associated with the second purse. 200. When attached to the interior of the first purse 110, the second purse 200 is in a position where items contained therein will be prone to stay within the second purse 200. The purse system 100, in some embodiments, can also include an alarm system 600 associated with the second purse. The alarm system 600 can include silent or audible alarms. In one embodiment, the alarm system includes one or more RFID tags. In one embodiment, both the first purse 110 and the second purse 200 can include individual alarms. One of the first purse and the second purse 200 may include a portion that enables an alarm in the other portion when the other portion is beyond a selected distance from the first portion.

A purse includes at least one compartment. The compartment includes a first edge and a second edge. The purse also includes a flap for enclosing the one compartment. The flap covers at least one of the first edge or the second edge when in the closed position. The first edge is positioned away from the second edge. The purse system also includes a strap attached to a first side and a second side at a position between the first edge and the second edge. The strap is configured to be substantially parallel to the first edge and the second edge when worn by a user. The strap further includes a first strap portion, and a second strap portion. The first strap portion includes a first connection portion, and the second strap portion is longer than the first strap portion. The second strap portion includes a second connection portion and a length adjustment mechanism. The first connection portion attached to the second portion to form the strap for attaching to a user. The purse, in some embodiments, includes an alarm, such as a silent alarm, an audible alarm, or an RF transmitter.

FIG. 7 is a schematic view of a purse having a global positioning sensor that can be used to locate the purse, according to an example embodiment. The global positioning sensor would include a global positioning receiver and a sending unit. The sending unit would take the global positioning data and send it to a predetermined or selected destination so that the purse could be located. In one embodiment, the global positioning system (“gps”) includes a device for attaching to a wireless network. When the purse is in an area having an unprotected wireless network, the sending unit communicates with the network and sends a communication including locational information to a predetermined or selected destination. The selected destination could be a security company or could be an email address of the user, in some embodiments. The gps sensor, in one embodiment, is sewn into the strap so that it is invisible to the person using the purse. In another embodiment, the gps sensor may be formed to look like a decorative portion of the purse, such as a button.

FIG. 8 is a front view of a purse 800 with a holster style strap 810 for attaching to the leg of a wearer, according to an example embodiment. The purse 800 also includes a device for attaching to a belt of the wearer. In one embodiment, the purse 800 includes a belt slot or a plurality of belt slots for attachment to the user's belt. In another embodiment, the purse 800 includes a set of snaps for directly attaching to the wearer's belt. In still another embodiment, the snaps are attached to short straps 820 with can be placed over the belt and then snapped to form a loop for the wearer's belt.

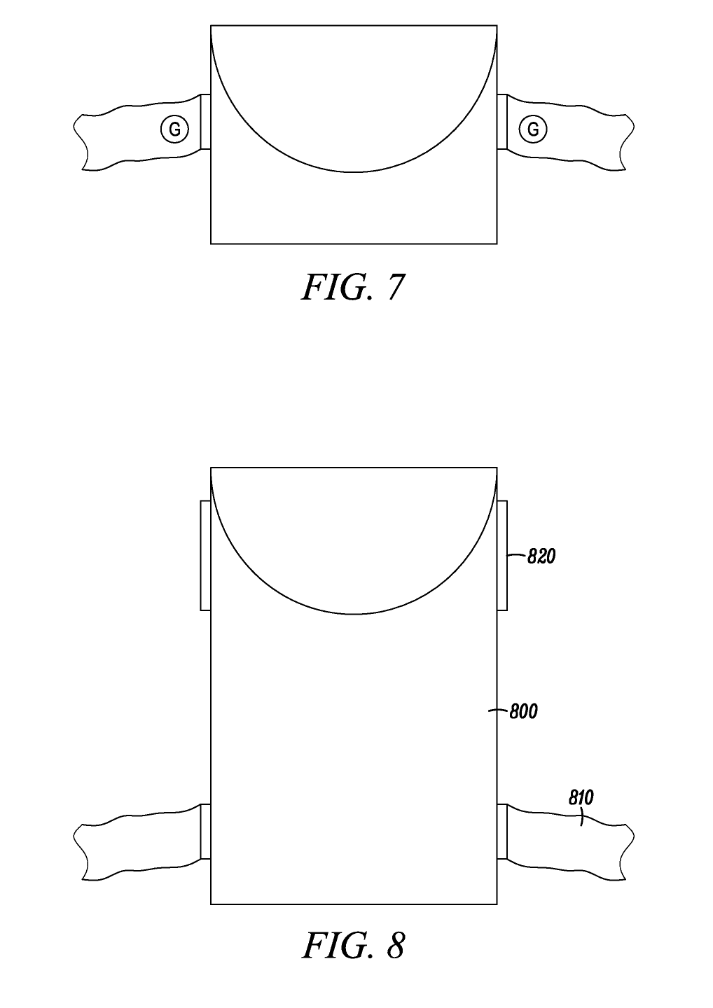

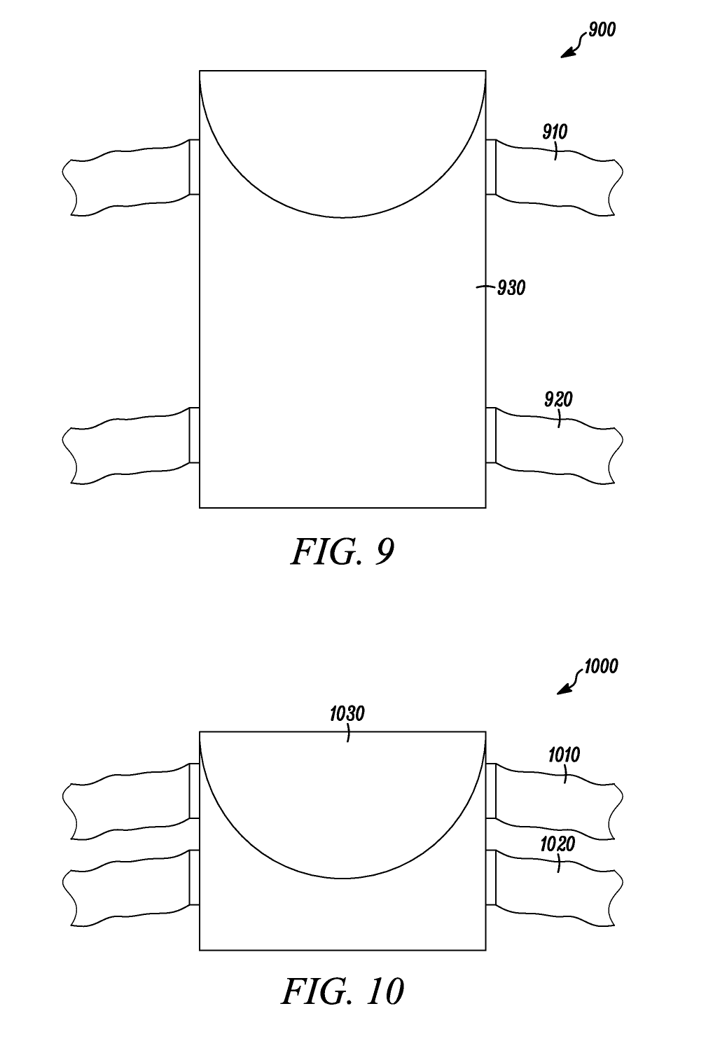

FIG. 9 is a front view of a purse 900 having a set of straps 910 and 920 for attaching to the waist and leg of a wearer, respectively, according to an example embodiment. The double strap includes the waist strap 910 which is generally longer that the leg strap 920. In some embodiments, the straps 910, 920 can be removably attached to the main body 930 of the purse. A hook and loop fastener, such as Velcro, can be used to removably attach the straps 910, 920 to the main body 930 of the purse 900.

FIG. 10 is a front view of a purse 1000 having a double set of straps for attaching to a wearer, according to an example embodiment. According to one embodiment, the purse 1000 includes a first strap 1010 and a second strap 1020 for attaching to any portion of a wearer. The straps 1010, 1020 are adjustable to any length. The straps 1010, 1020 can be twisted, criss-crossed or braided to form any sort of fashion wear. In some embodiments, the straps 1010, 1020 can be removably attached to the main body 1030 of the purse. A hook and loop fastener, such as Velcro, can be used to removably attach the straps 1010, 1020 to the main body 1030 of the purse 1000.

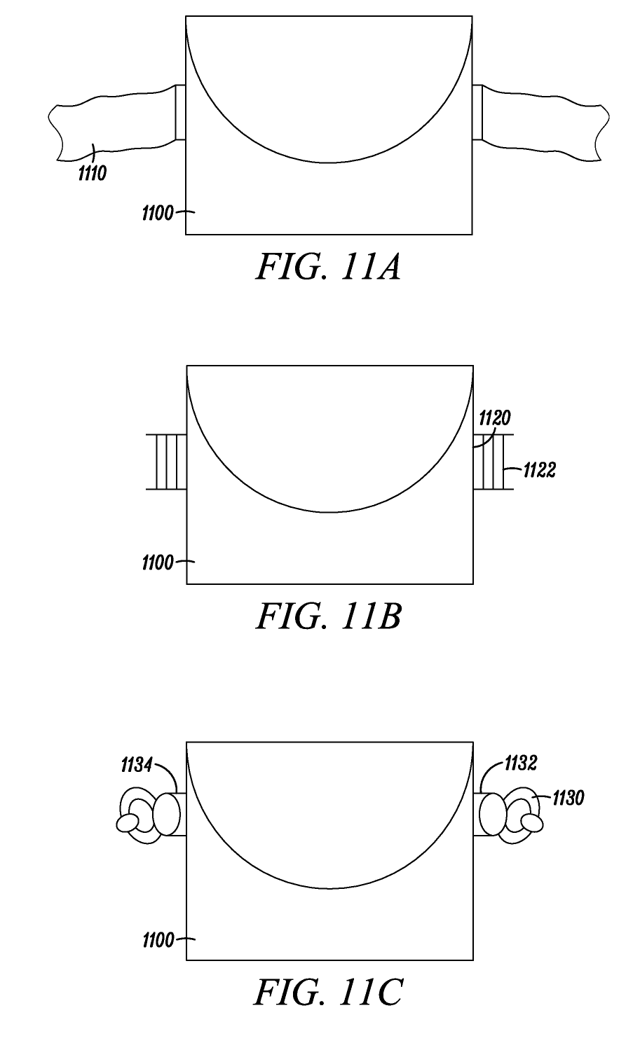

FIG. 11A, FIG. 11B, and FIG. 11C illustrate several example embodiments for attaching a purse 1100 to the belt of a user. FIG. 11A is a front view of a purse 1100 having a removably attachable strap 1110 for attaching to the waist of a wearer, according to an example embodiment.

FIG. 11B is a front view of a purse 1100 having a belt slot 1120 for attaching to a belt or other strap of a wearer, according to an example embodiment. The belt slot 1120 is dimensioned to receive most belts that a user might wear. As a result, the belt slot 1120 receives most belts the user would wear. The wearer attaches the purse 1100 by threading the belt, such as belt 1122, though the slot. Of course the purse will have to fit between belt loops on the wearer's pants (not shown). A “belt” 1122 need not merely be used to attach to a person's waist. It is contemplated that a belt 1122 could be used to attach to any portion of the user. Furthermore, it is contemplated that the belt 1122 could also be used to strap to another object.

FIG. 11C is a front view of a purse 1100 having at least one hook 1130 for attaching to a belt or other strap of a wearer, according to an example embodiment. In the embodiment shown, the purse 1100 includes a first strap 1132 and a second strap 1134 which attach to the hook 1130. The hooks 1130 are dimensioned to receive a strap, such as a belt or other strap, the user may want to attach the purse to. In some embodiments, the hooks 1130 include a latching mechanism to latch to openings in the strap the user selects to attach the purse to.

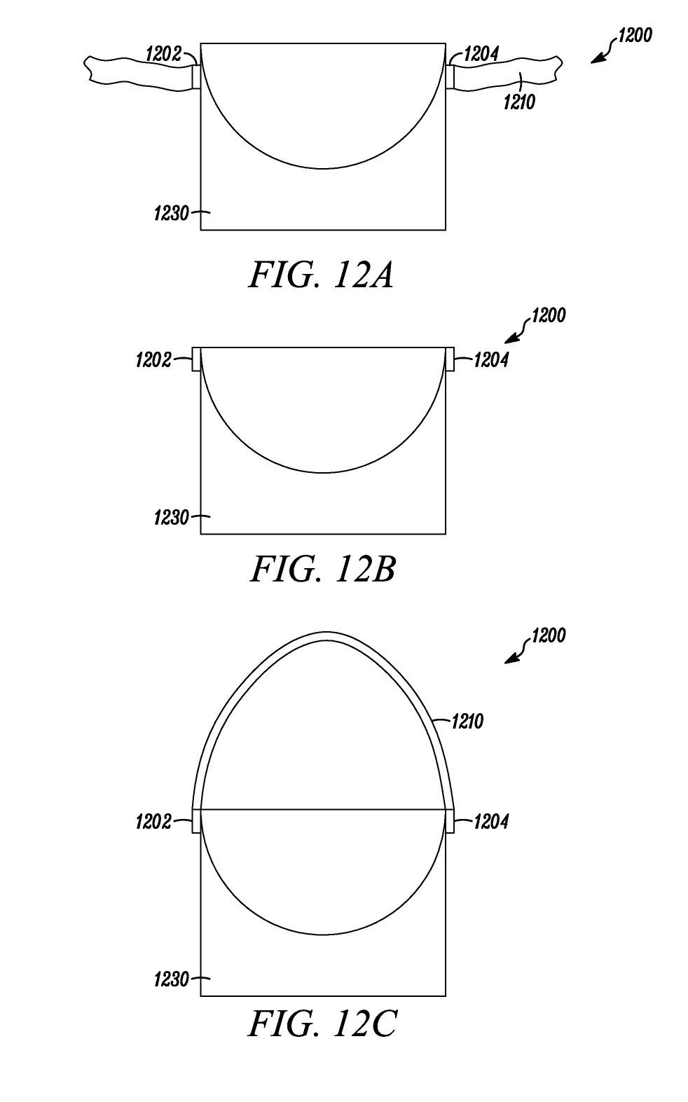

FIG. 12A, FIG. 12B, and FIG. 12C illustrate several example embodiments of a convertible purse 1200. The purse 1200 includes a main body 1230 having several attachment points 1202 and 1204 to which a strap can be removably attached. The attachment points 1202 and 1204 are configured to look fashionable when a strap is not attached thereto or when a strap is attached thereto.

FIG. 12A is a front view of the purse 1200 having a removably attachable body strap 1210 or attaching to a wearer, according to an example embodiment. The removably attachable body strap 1210 is adjustable so that the user can create a strap for any use imaginable. The body attachment strap 1210 is shown with broken ends so that the length can be any length. In one embodiment, several straps 1210 can be provided of varying lengths. In another embodiment, the several straps 1210 can also be adjustable. In this way, a user or wearer can select a length that is close for a selected purpose and then adjust the strap 1210 so that it is just right for the application.

FIG. 12B is a front view of the purse 1210 shown in FIG. 12A without the removably attachable body strap 1210 or configured as a clutch purse, according to an example embodiment.

FIG. 12C is a front view of the purse shown in FIG. 12A having a removably attachable body strap 1210 attached to the purse so the purse of a length that allows the purse to be configured as a hand held or shoulder carried purse, according to an example embodiment.

Although a few variations have been described and illustrated in detail above, it should be understood that other modifications are possible. In addition it should be understood that the logic flow depicted in the accompanying figures and described herein do not require the particular order shown, or sequential order, to achieve desirable results. Other embodiments may be within the scope of the following claims. The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

What is claimed is:

1. A purse system comprising:
a first purse having a first connection point therein;
a second purse, having a second connection point therein for removably attaching the second purse to a position within the first purse, the second purse being smaller than the first purse.

2. The purse system of claim 1 the second purse includes a strap of sufficient length to attach to a person's appendage.

3. The purse system of claim 1 the second purse includes a strap of sufficient length to wrap around a person's arm.

4. The purse system of claim 1 the second purse includes a strap of sufficient length to wrap around a person's leg.

5. The purse system of claim 1 the strap of the second purse includes a third connection point which interacts with the second connection point.

6. The purse system of claim 5 wherein the third connection point on the strap of the second purse is substantially identical to the first connection point of the first purse.

7. The purse system of claim 1 wherein the second purse is in a position where items contained therein will be prone to stay within the second purse when the second purse is connected to the first purse.

8. The purse system of claim 1 further comprising an alarm system associated with the second purse.

9. The purse system of claim 8 wherein the alarm includes an RFID tag .

10. The purse system of claim 8 further comprising a second alarm system associated with the first purse.

11. A purse comprising:
at least one compartment, the compartment including a first edge and a second edge;
a flap for enclosing the one compartment, the flap covering at least one of the first edge or the second edge when in the closed position, the first edge positioned away from the second edge;
a strap attached to a first side and a second side at a position between the first edge and the second edge, the strap configured to be substantially parallel to the first edge and the second edge when worn by a user, the strap further comprising:
a first strap portion, the first strap portion including a first connection portion; and
a second strap portion longer than the first strap portion, the second strap portion including a second connection portion and a length adjustment mechanism, the first connection portion attached to the second portion to form the strap for attaching to a user.

12. The purse of claim 11 further comprising an alarm.

13. The purse of claim 12 wherein the alarm is an audible alarm.

14. The purse of claim 12 wherein the alarm is an silent alarm.

15. The purse of claim 12 wherein the alarm includes an RF transmitter.
